(19) United States
(12) Patent Application Publication
(10) Pub. No.: US 2005/0216922 A1
(43) Pub. Date: Sep. 29, 2005

(54) Method and system for access and modification of formatted text

(75) Inventors: Alexei Mogilevsky, Bellevue, WA (US); Peter Francis Ostertag, Woodinville, WA (US); Benjamin M. Westbrook, Redmond, WA (US); Evgeny N. Veselov, Sammamish, WA (US)

Correspondence Address: Homer L. Knearl;Merchant & Gould P.C., P.O. Box 2903, Minneapolis, MN, 55402-0903, US

(73) Assignee: Microsoft Corporation

(21) Appl. No.: 10/813,398

(22) Filed: Mar. 29, 2004

(51) Int. Cl. G06F 3/00

(52) U.S. Cl. 719/328

(57) ABSTRACT

Embodiments of the present invention relate to methods, systems, and computer-readable media for editing an object displayed by a computer system. Editing comprises detecting an edit operation for an object displayed on a video display of a computer system. An edit operation request is then sent to an abstraction layer via an application program interface provided by the abstraction layer to initiate editing of the object by the abstraction layer. The abstraction layer is a text object model that has two models, a data model for accessing persistent content of text, and a view model for accessing presentation and interaction appearance of text. The text object model has several abstract classes and receives the edit operation request, determines the type of container in which the object is displayed based on properties related to the object to be edited, determines the operations required, incorporating all traditional text manipulation operations including actual editing, layout manipulations and text formatting. The abstraction layers read set of properties related to the object and the container in which the object is displayed in accordance with user instructional interactions.

### TECHNICAL FIELD

The present invention relates generally to the field of computer methods and systems for accessing and modifying textual data and more particularly to a formatted text programming interface model providing a layer of abstraction for text processing and editing operations.

### BACKGROUND OF THE INVENTION

A visual display such as a graphical user interface presented by software may include objects and containers. An object can be any item on a visual display. A container can be an object upon or within which other objects are presented. For example, a container, such as a spreadsheet or word processing document, may include a number of objects, such as cells, graphics, user interface elements, and others. The objects within such a container may have defining parameters such as a defined presentation size, position, etc. This presentation may be defined and edited dynamically by the software displaying the container and objects. For example, an object may be moved, resized, rotated, etc. within its container during execution of the software presenting that object. The presentation may also include various forms of text objects that can be dynamically edited. These editing actions may be initiated by a user action such as dragging and dropping an object using a mouse or other pointing device or may be initiated by the software itself in response to some other event.

Typically, a body of code within the application is responsible for arranging elements of a visual display such as objects and containers. For example, an application program presenting a number of objects includes code representing a layout editor, sometimes referred to as a “form editor” or “2D editor,” for arranging and/or editing the appearance of the containers and objects presented by that application. However, to function properly, the layout editor requires specific, prior knowledge of the parent container for the objects to be edited. For example, the layout editor must have specific knowledge of the type of container, the size of the container and other attributes for that container in order to properly present the objects. This information is important to the layout editor because an object may be sized, positioned, etc, within its parent container differently based on the type of container in which it is placed. There are many different rich format text editors utilized today including a multiplicity of formats and APIs although conceptually text is always a linear sequence of characters with associated properties. Each specific editor has a substantial amount of code necessary to perform the manipulations of the text.

For a layout editor to have such specific knowledge of the parent container and change properties of the container and textual objects within that container based on that knowledge and the editing operation, the editor of the application also typically consists of extensive code. Further complicating matters, an object may be placed on an arbitrary surface in a container that may arbitrarily arrange its children. Therefore, the changes made by the editor used may be ineffective.

As such, there is no simple manner in which an application may arrange or edit objects on a display, or any other output device, without consideration of the type of container in which the object will be placed. Additionally, a typical application's layout and text editor is limited to editing only objects within a container for which it has specific knowledge. It is with respect to these considerations and others that the present invention has been made.

### SUMMARY OF THE INVENTION

In accordance with the present invention, the above and other problems are solved by incorporation into an application program interface (API) a text object model that includes a new abstraction layer for use when performing rich formatted text editing operations, layout rendering operations, and text construction. The abstraction layer provides a number of interfaces that may be used by external application programs, regardless of platform, to perform various rich text-editing operations regardless of the specific word processing programs that originally would otherwise have been involved. For example, the abstraction layer may also provide for moving, resizing, reordering, etc. a specified object. Through the abstraction layer interfaces to each of these operations, an application program may affect layout of the text and the text editing operation without code specific to that editing operation and without knowledge of the object's parent container.

In one embodiment, the present invention relates to a system for editing objects, and in particular, rich formatted textual objects, displayed on a video display or otherwise outputted to a peripheral device. The system comprises a processor and a memory coupled with and readable by the processor. The memory contains instructions that, when executed by the processor, cause the processor to detect a user interaction, such as an edit operation for an object, for example, displayed on a video display of a computer system.

An edit operation request is then sent to an application program interface (API) having an abstraction layer provided by the text object model in accordance with the invention to initiate editing of the object by the abstraction layer. The abstraction layer, e.g., the text object model, receives the edit operation request and determines the type of container in which the object is displayed based on properties related to the object to be edited. The abstraction layer then reads a set of properties related to the object to be edited and a set of properties related to the container in which the object is displayed. The abstraction layer may then edit the object based the properties of the container and object by modifying one or more of the properties of the container and object.

The invention may be implemented as a computer process, a computing system or as an article of manufacture such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

These and various other features as well as advantages, which characterize the present invention, will be apparent from a reading of the following detailed description and a review of the associated drawings.

### BRIEF DESCRIPTION OF THE DRAWINGS

FIG. 1 illustrates abstraction of a system incorporating a text editing object model according to an embodiment of the present invention.

FIG. 2 illustrates an example of a suitable computing system environment on which embodiments of the invention may be implemented.

FIG. 3 illustrates a basic relationship between an application and a text object model in accordance with the embodiment of the present invention shown in FIG. 1.

FIG. 4 illustrates functional components of the text object model system according to the embodiment of the present invention shown in FIG. 3.

### DETAILED DESCRIPTION OF THE INVENTION

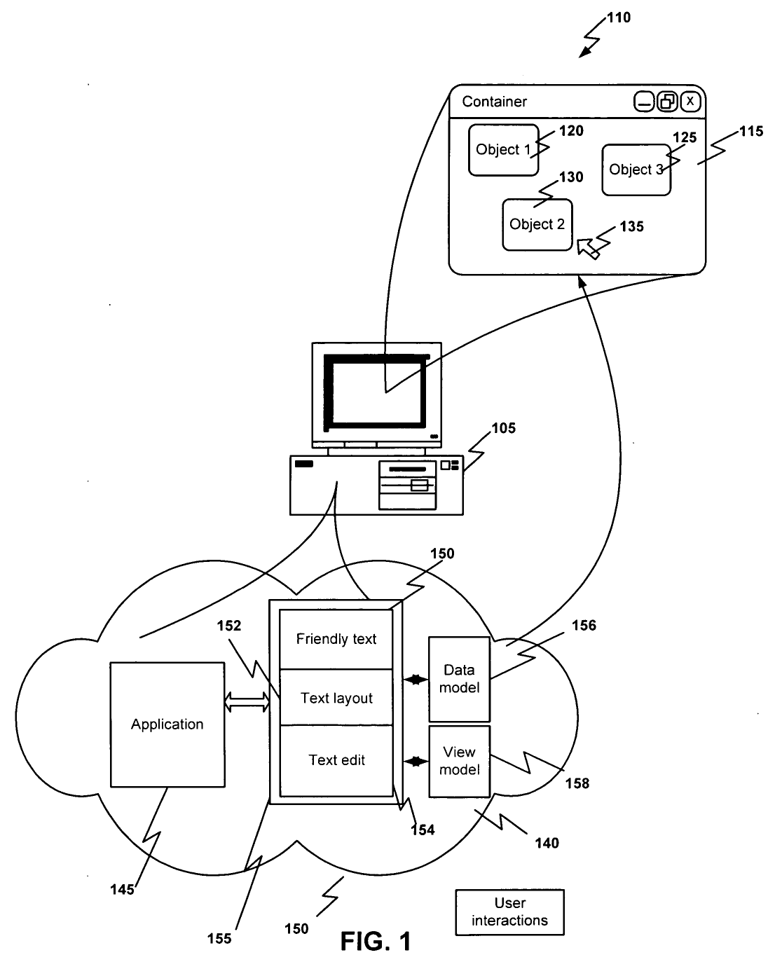

FIG. 1 illustrates text object model operations according to an embodiment of the present invention. In this example, a computer system 105 executes software 140 and provides a display 110 of information. The display 110 includes a container 115 that in turn includes a number of objects 120-130. The container 115 may be, as shown here, a window or another type of container such as a desktop, a document, a folder, or other object. The objects 120-130 within the container may be any of a variety of different objects such as user interface elements, graphics, blocks of text, etc. that may be arranged in any of a variety of ways. For example, the objects 120-130 may be text objects arranged by absolute position based on x, y coordinates within the container 115 as shown here, flowing from left to right or right to left along the top or bottom of the container 115, docketed to an edge of the container 115 such as the left side or right side of the container 115, some combination of these arrangements, or in another arrangement.

Also shown on the display 110 is a cursor 135 that may be moved by a user of computer system 105 using a mouse or other pointing device to select and/or manipulate the objects 120-130. As used herein, objects primarily include rich formatted text, images, or embedded images along with associated text and textual properties. For example, a user, by manipulating a mouse, may position the cursor over or within an object and select and move, i.e., drag and drop, an object to move that object. In another example, a user may resize or rotate an object by dragging and dropping an edge or corner of the object, or modify the text within that object or its properties.

Software 140 executed on the computer system 105 may include one or more applications 145. The application 145, such as a word processor, spreadsheet, web browser, or other program, may generate the container 115 and/or the objects 120-130 contained therein. To arrange, render and edit the objects, the application uses one of the text object model interface abstraction layers 150, 152, and 154. That is, rather than the application directly arranging and editing the objects 120-130 which would require specific layout algorithms within the application itself, the application 145 calls, invokes, instantiates, or otherwise initiates execution of one of the text object model abstractions 150, 152, or 154 in the text object model interface 155. The text object model interface 155 in turn calls, invokes instantiates execution of either a data model abstraction layer 156 or a view model abstraction layer 158. These layers in turn draw from a data text-backing store or a view model-backing store. The data model provides access to persistent content of text, e.g. characters, embedded objects, formatting and structuring elements. The view model provides access to presentation and interaction appearance of textlines and other layout blocks, such as, dynamic highlights of various kinds (selection, misspellings), and caret marks.

When a user of the computer system 105 uses a mouse or other pointing device to select, edit or manipulate the objects 120-130, the application 145 may use an abstraction layer 150, 152 or 154 provided by the interface 155 to initiate an appropriate editing operation. For example, a user may manipulate the cursor 135 to select and move, i.e. drag-and-drop, one of the objects 130. In such a case, the application 145 may call, invoke, instantiate, or otherwise initiate execution of a move method or operation via the abstraction layer 152 through the corresponding interface 155 incorporating the abstraction layer 152 through tapping into the view model 158. In this way, the application 145 need not contain code for editing or arranging the objects 120-130 in the container 115. The application 145 simply detects the editing operation, and passes the appropriate parameters to the abstraction layer 152 through the API 155.

The abstraction layer 152 may represent a class with specific knowledge, i.e., properties of the object and its container. Having this knowledge allows the abstraction layer 150, 152, or 154 to make specific changes to affect the editing action. The abstraction layer 150, 152, or 154, by presenting a number of methods, allows editing operations such as move, resize, rotate, stretch, skew, etc. to be applied to a container or objects within that container without requiring the application 145 to specifically know how objects are positioned or arranged within the container. That is, the abstraction layer 150, 152, or 154 translates logical editing operations such as text edit, move or resize into changes to object-specific properties such as width, height, absolute position, etc. depending upon the object and container. Additionally, the abstraction layers 150, 152, and 154 handles editing of objects when the container controls the display of the object. For example, the parent container may, depending upon its type, control the positioning of the object. In such a case, the abstraction layer 152 may edit the properties of the container to affect the editing operation on the object.

The abstraction layer in the API 155 may also allow more than one application 145 to easily modify the same object and/or container. For example, since specific knowledge of the object and container is available to the abstraction layer 150, 152, and 154, applications do not need to obtain or maintain this information. In order to edit an object or container, the application simply accesses the logical editing operation via the appropriate interface of the abstraction layer. That is, for example, if the abstraction layer 150 is implemented as a class, multiple applications may access the logical editing operations of that class by instantiating an object of that class and invoking the method for performing the desired operation using the appropriate interface.

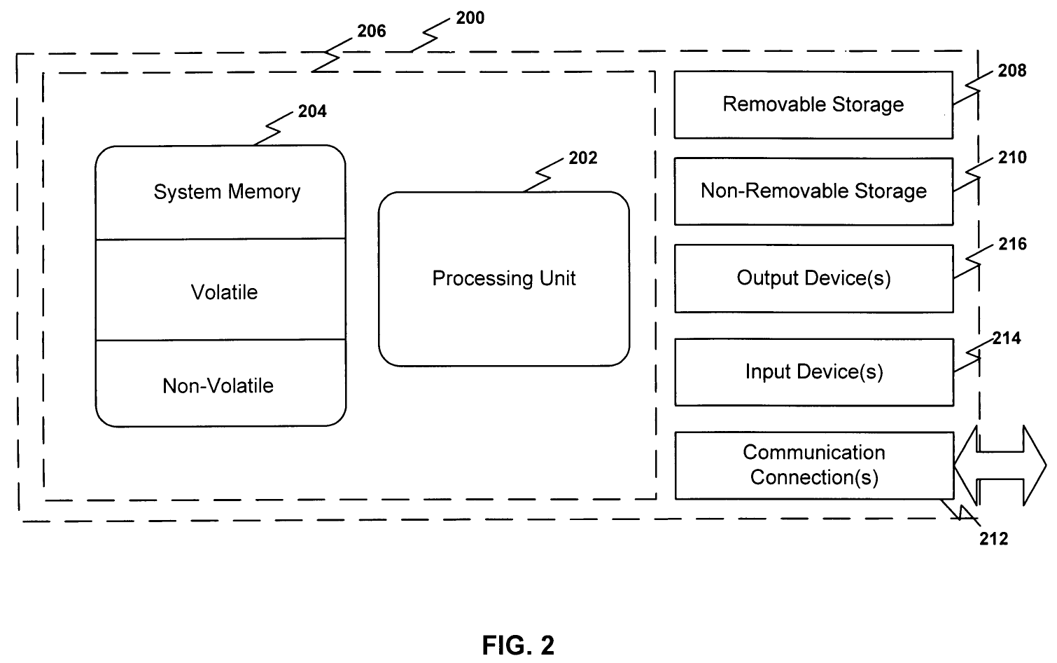

FIG. 2 illustrates an example of a suitable computing system environment on which embodiments of the invention may be implemented. This system 200 is representative of one that may be used to serve as the computer system 105 described above. In its most basic configuration, system 200 typically includes at least one processing unit 202 and memory 204. Depending on the exact configuration and type of computing device, memory 204 may be volatile (such as RAM), non-volatile (such as ROM, flash memory, etc.) or some combination of the two. This most basic configuration is illustrated in FIG. 2 by dashed line 206. Additionally, system 200 may also have additional features/functionality. For example, device 200 may also include additional storage (removable and/or non-removable) including, but not limited to, magnetic or optical disks or tape. Such additional storage is illustrated in FIG. 2 by removable storage 208 and non-removable storage 210. Computer storage media includes volatile and nonvolatile, removable and non-removable media implemented in any method or technology for storage of information such as computer readable instructions, data structures, program modules or other data. Memory 204, removable storage 208 and non-removable storage 210 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by system 200. Any such computer storage media may be part of system 200.

System 200 typically includes communications connection(s) 212 that allow the system to communicate with other devices. Communications connection(s) 212 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

System 200 may also have input device(s) 214 such as keyboard, mouse, pen, voice input device, touch input device, etc. Output device(s) 216 such as a display, speakers, printer, etc. may also be included. All these devices are well know in the art and need not be discussed at length here.

A computing device, such as system 200, typically includes at least some form of computer-readable media. Computer readable media can be any available media that can be accessed by the system 200. By way of example, and not limitation, computer-readable media might comprise computer storage media and communication media.

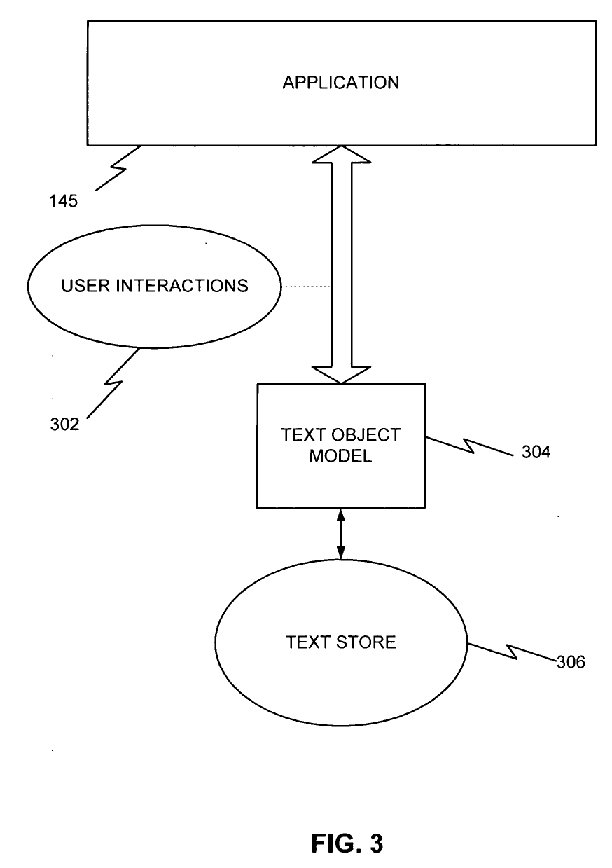

FIG. 3 illustrates conceptual interrelationships between the text object model in accordance with an embodiment of the invention and an application 145. Basically the operations 300 in this embodiment of the invention may be viewed as an abstraction between user interactions 302 and a text store 304. The user interactions 302 may each include such operations as typing, rendering, defining layout of the object and editing the content of the object. The abstraction generally, may be viewed as a text object model 306 that receives direction and interfaces with the user interactions 302 and in turn draws from one or more text stores 304 to accomplish the actions required.

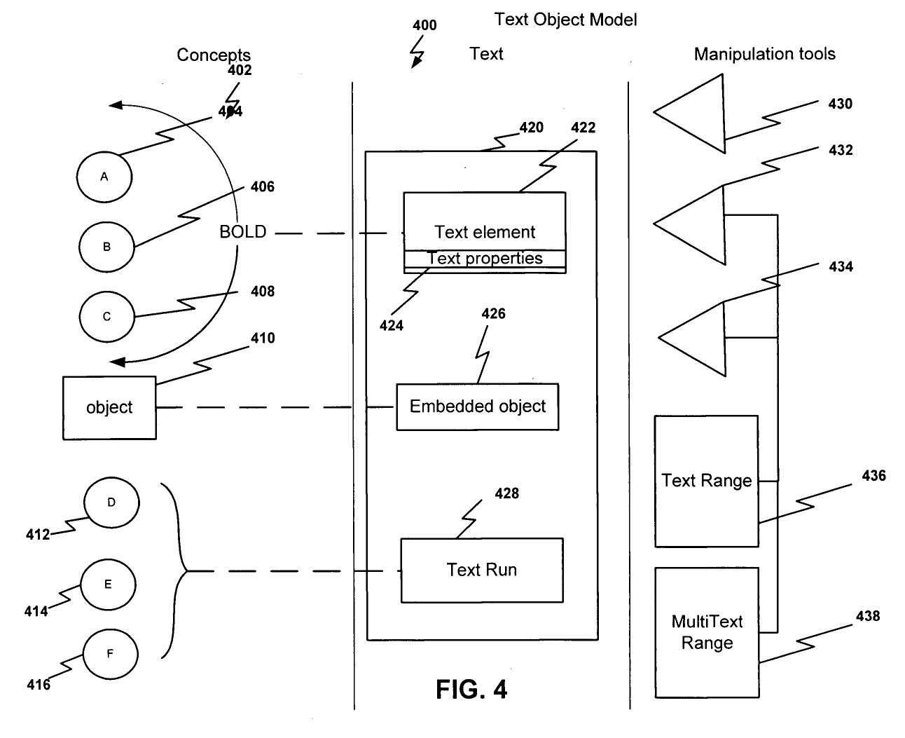

FIG. 4 illustrates these concepts further. For example, a group of conceptual objects 402 might include rich formatted text objects 404-416. One or more of these objects may also include an embedded graphical or bitmap image alone, or in conjunction with typical rich formatted text. Each of the objects 404-416 has unique properties associated with it. These properties are abstracted in a text container 420. For example, objects 404, 406 and 408 may be bold. Each of these objects 404, 406, and 408 has a text element 422 and associated text properties 424. Object 410 is an embedded object 426. Objects 412, 414 and 416 each have common properties characterized as text run 428.

The application program interface 155, i.e. text object model 400 in accordance with an embodiment of the present invention has two fundamental parts—data model 156 and view model 158. Data model 156 provides access to persistent content of text. For example, these include characters, embedded objects, and formatted and structuring elements. The view model 158 provides access to presentation and interaction appearance of text: lines and other layout blocks, dynamic highlights of various kinds, such as selection, misspellings, carets, etc. This model is represented by an abstract class “TextView” and an abstract class “TextHighlight”. Note that TextHighlight is actually part of the data model. The view model is a superset of the data, adding additional layout functionality such as hit testing. TextHighlight is data that serves as input to the layout engine, just like TextContainer. These models are provided in the backing store of the API 155.

The text object model 400 in accordance with an embodiment of the present invention, in more detail, has four basic abstract classes. These are: “TextContainer”, which is a storage for some linear piece of text with minimal editing capabilities; “TextPosition”, which is a tool for identifying locations within text and getting access to text content in these locations; “TextNavigator”, which is a tool for moving from one position to another; and “TextView”, which is a view related functionality for hit testing, layout-aware movement, and dynamic text highlights. In addition, there are other classes in text object model 400. These include “TextRange”, “Text MultiRange”, and “TextHighlight”, which are non-abstract, and are implemented on top of the four abstract classes set forth above.

As a whole, text data model 156 is represented by the abstract class TextContainer. This class represents the entire text content and provides text editing operations on it. The mechanism for accessing data in TextContainer is in the abstract class TextPosition. TextPosition may be viewed as a pointer to some location within the TextContainer, such as between two neighboring symbols. All editing operations use TextPositions as references.

The object allowing navigation from one TextPosition to another is TextNavigator. This is a class derived from TextPosition, thus inheriting all its content exploring properties. The classes TextContainer, TextPosition and TextNavigator are abstract classes that represent a contract between internal control implementation and higher-level text processing operations. For example, a tool for higher level editing operations is non-abstract class TextRange. TextRange allows for applying formatting across elements, paragraphs, and even nested TextContainer objects. It also supports such functionality as Cut/Copy/Past operations.

To access text object model (Text OM) from all such various text containing elements we use a mechanism based on “IServiceProvider” interface. Service of type TextView should be requested from an element to detect if it supports Text OM protocol. The following statement gets an access to text view model of some “element”:
TextView textView=((IServiceProvider)element).GetService(Typeof(TextView)) as TextView;

It is assumed that various engines utilizing the text object model for rendering, text editing, and accessibility will use this mechanism of unified access to text content.

Types within the text object model 400 in an embodiment of the present invention are preferably grouped into following categories: Framework classes—standard classes used in Text Object Model; Base types—enumerations introduced by Text OM to serve as parameters in all other classes; Text Model classes; Controls and Implementation-specific classes; and Text Editor classes. The first of these, Framework classes, include the following:
class DependencyObject—generic class used as an abstract representative for text structuring elements.
class DependencyProperty—an object used as a text formatting property identifier. Properties are to be defined on DependencyObjects.
class UIElement—an object used as atomic element in text. Such data as images, text frames, tables, sub-forms etc. are represented as UIElements. In this interface though we expose them simply as “objects” to allow even more flexibility for control internal structure. The rendereing engine in one implementation only processes UIElements and ignores everything else.
class TextElement—this class (and its subclasses like Paragraph, Inline, etc.) is used for text formatting elements. In abstract interface the more generic DependencyObject is used, but built-in editing includes more concrete TextElements. If the data store uses different objects, then built-in editing is disabled on that text content.

Base types may include the following enumerations among others:
enum LogicalDirection—one of: forward and backward. Represents a direction in linear text space. Forward direction corresponds to a an order of reading, so for some languages it means left-to-right, for others—right to left.
enum TextSymbolType—one of: Character, Object, ElementBegin, ElementEnd, None. Identifies the type of content appearing around a given position of a text.

Text Object Model in an embodiment of the present invention is defined, for example, in Microsoft Windows® as System.Windows.Documents namespace.

The following provides further definition of the various classes in an embodiment of the present invention. Abstract Class TextContainer is an object representing the whole linear text content.

```
abstract class TextContainer : UIContextObject
{
    // Boundaries
    abstract DependencyObject Parent { get; }
    abstract TextPosition Start { get; }
    abstract TextPosition End { get; }
    // Editing operations
    abstract void InsertText(
        TextPosition position, string text);
    abstract void DeleteContent(
        TextPosition start, TextPosition end);
    abstract void InsertEmbeddedObject(
        TextPosition position, object embeddedObject);
    abstract void DeleteEmbeddedObject(
        TextPosition position, LogicalDirection direction);
    abstract void InsertElement(
        TextPosition start, TextPosition end,
        Type textElementType);
    abstract void ExtractElement(
        TextPosition position);
    abstract void SetValue(
        TextPosition position,
        DependencyProperty property, object value);
    abstract void SetValues(
        TextPosition position,
        LocalValueEnumerator values);
    abstract void ClearValue(
        TextPosition position,
        DependencyProperty property);
}
```

Abstract class TextPosition defines a mechanism for identifying locations in text content that would survive editing operations, so that to keep reference to certain text portions during editing.

TextPositions are never movable. Once created TextPosition maintains the following invariant: every symbol which was to the left of the position, until it stays in the text, remains to the left of it; every symbol which was to the right remains to the right.

```
abstract class TextPosition : UIContextObject, IComparable
{
    // Life-time properties
    abstract TextContainer TextContainer { get; }
    abstract LogicalDirection Gravity { get; }
    // Comparing positions
    override int GetHashCode( );
    abstract int CompareTo(
        TextPosition position);
    int IComparable.CompareTo(
        object position);
    override bool Equals(
        object position);
    static bool operator < (TextPosition p1, TextPosition p2);
    static bool operator <= (TextPosition p1, TextPosition p2);
    static bool operator > (TextPosition p1, TextPosition p2);
    static bool operator <= (TextPosition p1, TextPosition p2);
    static bool operator == (TextPosition p1, TextPosition p2);
    static bool operator != (TextPosition p1, TextPosition p2);
    static bool Equal(TextPosition p1, TextPosition p2);
    static bool LessThan(TextPosition p1, TextPosition p2);
    static bool LessThanOrEqual(TextPosition p1, TextPosition
p2);
    static bool GreaterThan(TextPosition p1, TextPosition p2);
    static bool GreaterThanOrEqual (TextPosition p1, TextPosition
p2);
    static TextPosition Min(TextPosition p1, TextPosition p2);
    static TextPosition Max(TextPosition p1, TextPosition p2);
    // Integral indexing
    abstract int GetDistanceTo(
        TextPosition position);
    // Accessing text content from position
    abstract TextSymbolType GetSymbolType(
        LogicalDirection direction);
    abstract int GetTextLength(
        LogicalDirection direction);
    abstract int GetText(
        LogicalDirection direction, int maxLength,
        TextPosition limit, char[ ] chars, int startIndex);
    string GetText(
        LogicalDirection direction);
    abstract UIElement GetEmbeddedObject(
        LogicalDirection direction);
    abstract Type GetElementType(
        LogicalDirection direction);
    abstract Type GetElementType( );
    abstract bool HasEqualScope(
        TextPosition position);
    abstract object GetValue(
        DependencyProperty property);
    abstract object GetElementValue(
        LogicalDirection direction, DependencyProperty property);
    abstract object ReadLocalValue(
        DependencyProperty property);
    abstract object ReadElementLocalValue(
        LogicalDirection direction, DependencyProperty property);
    abstract LocalValueEnumerator GetLocalValueEnumerator(
        );
    abstract LocalValueEnumerator
GetElementLocalValueEnumerator(
        LogicalDirection direction);
    // Creating text positions
    abstract TextPosition CreatePosition(
        int distance, LogicalDirection gravity);
    TextPosition CreatePosition( );
    TextPosition CreatePosition(
        LogicalDirection gravity);
    abstract TextNavigator CreateNavigator(
        int distance);
    TextNavigator CreateNavigator( );
    abstract bool IsAtCaretUnitBoundary(
        LogicalDirection direction);
}
```

Abstract class TextNavigator is derived from TextPosition thus providing all context exploration functionality. In addition to it TextNavigator can be moved forward and backward over text content allowing investigating its structure.

```
abstract class TextNavigator : TextPosition
{
    // Gravity
    abstract void SetGravity(
        LogicalDirection gravity);
    // Movements
    abstract TextSymbolType Move(
        LogicalDirection direction);
    abstract TextSymbolType MoveToDistance(
        int distance);
    abstract void MoveToPosition(
        TextPosition position);
    abstract void MoveToElementEdge(
        ElementEdge edge);
    virtual bool MoveToCaretUnit( // normalization
        LogicalDirection direction);
    virtual bool MoveToNextCaretUnit(
        LogicalDirection direction);
    virtual bool MoveToNextCaretUnit(
        LogicalDirection direction, TextPosition limit);
}
```

TextRange is a non-abstract class intended for high-level editing operations on texts. It is just a wrapper for a pair of TextPositions with a bunch of convenience methods for editing and formatting.

```
class TextRange
{
    // Constructors
    TextRange(
        TextRange range);
    TextRange(
        TextRange range, bool movable);
    TextRange(
        TextPosition position);
    TextRange(
        TextPosition start, TextPosition end);
    TextRange(
        TextPosition start, TextPosition end, bool movable);
    TextRange(
        TextPosition start, TextPosition end,
        LogicalDirection startGravity, LogicalDirection
endGravity);
    TextRange(
        TextPosition start, TextPosition end,
        LogicalDirection startGravity, LogicalDirection
endGravity,
        bool movable);
    // Text container
    TextContainer TextContainer { get; }
    // Range boundaries
    TextPosition Start ( get; set; }
    TextPosition End { get; set; }
    // Movability
    bool IsMovable { get; }
    // Emptiness
    bool IsEmpty { get; }
    // Positional relationships
    bool Contains(
        TextPosition position);
    bool Contains(
        TextRange range);
    // Range movement
    void MoveToPosition(
        TextPosition position);
    void MoveToPositions(
        TextPosition start, TextPosition end);
    void MoveToRange(
        TextRange range);
    void MoveToCaretUnits( );
    bool MoveToNextCaretUnit(
        LogicalDirection direction);
    bool MoveToNextCaretUnit(
        LogicalDirection direction, TextPosition limit,
        bool collapse);
    void MoveStart(
        LogicalDirection direction);
    void MoveStart (
        LogicalDirection direction, TextPosition limit);
    void MoveEnd (
        LoicalDirection direction);
    void MoveEnd (
        LogicalDirection direction, TextPosition limit);
    // Accessing range content
    string Text { get; set; }
    // Tests for editing availability
    // Editing operations
    void DeleteContent( );
    void Append(string text);
    void AppendEmbeddedObject(object embeddedObject);
    TextRange AppendElement(Type textElementType);
    void SetElementValue(
        DependencyProperty property, object value);
    void ClearElementValue(
        DependencyProperty property);
    void InsertElement(Type textElementType);
    void Apply(LocalValueEnumerator values);
    void Apply(DependencyProperty property, object value);
    void Apply(DependencyProperty property, object value,
        Type blockType);
    void Clear(DependencyProperty property);
    void Clear(DependencyProperty, Type blockType);
    void AppendBreak(Type textElementType);
    void RemoveBreaks(Type textElementType);
    string GetXml(
        string format, bool withRangeMarkers);
    void GetXml(
        XmlTextWriter writer,
        string format, bool withRangeMarkers);
    void AppendXml(
        string xmlString);
    void AppendXml(
        XmlTextReader reader);
    // Find support
    bool Find(
        string pattern, FindOptions options);
    bool Find(
        string pattern, FindOptions options, CultureInfo
cultureInfo);
    bool Find(
        string pattern, FindOptions options,
        TextPosition limit);
    bool Find(
        string pattern, FindOptions options, CultureInfo
cultureInfo,
        TextPosition limit);
    // Move notification
    event EventHandler Moved;
}
class TextRangeMovedEventArgs : EventArgs
{
    // Constructor
    TextRangeMovedEventArgs(
        TextPosition oldStart, TextPosition oldEnd);
    // Properties
    TextPosition OldStart { get; }
    TextPosition OldEnd { get; }
}
```

Non-abstract Class TextMultiRange represents a collection of simple TextRanges. It provides a functionality for attaching some custom information with disjoint regions of text-across any structural and formatting boundaries. This class is helpful for selection, misspelled word collections, annotations etc.

```
class TextMultiRange
{
    // Constructor
    TextMultiRange( );
    // Simple ranges collection
    virtual void AddRange(TextRange simpleRange);
    virtual void RemoveRange(TextRange simpleRange);
    virtual void AddRange(TextMultiRange multiRange);
    virtual void RemoveRange(TextMultiRange multiRange);
    // Change otifications
    // Fired on Add/Remove and on any of TextRange.Moved
    virtual event TextMultiRangeMovedHandler Moved;
    // Range containment
    bool Contains(TextPosition position);
    bool Contains(TextRange simpleRange);
    bool Contains(TextMultiRange multiRange);
    // Range structure traversal
    virtual ICollection GetRangesAtPosition(
        TextPosition position, TextRangeEnds ends);
    virtual TextPosition GetNextIntersection(
        TextPosition start, TextPosition end,
        LogicalDirection direction);
}
class TextMultiRangeMovedEventArgs : TextRangeMovedArgs
{
    // Constructor
    TextMultiRangeMovedEventArgs(
        TextRange range, TextPosition oldStart, TextPosition
oldEnd);
    // Properties
    TextRange TextRange { get; }
}
[Flags]
enum TextRangeEnds
{
    Start = 1,
    End = 2,
}
```

Abstract Class TextView represents presentational characteristics of the text container. Text container itself is available from this interface via TextContainer property. This interface is an entry point in a text-containing element for all text-related services.

```
abstract class TextView
{
    // Underlying text data model
    TextContainer TextContainer { get; }
    // HitTesting
    TextPosition GetTextPositionFromPoint(
        Point point, bool snapToText, out bool endOfLine);
    Rect GetEdgeFromTextPosition(
        TextPosition position, bool endOfLine,
        LogicalDirection direction);
    // Layout information inquiry
    bool MoveToLine(
        TextNavigator navigator, bool endOfLine,
        Double suggestedX, int count);
    TextRange GetLineRange(
        TextPosition position, bool endOfLine);
        // Highlights
    TextHighlight Highlights;
}
```

Class TextHighlight is used in TextView class for applying temporary fonnatting (“visual highlight”) for various parts of text presentation. Such highlight is not considered as part of text content, so the same text content may have different highlights in some other view—at the same time.

```
class TextHighlight : TextRange
{
    // Constructors
    TextHighlight(
        TextPosition start, TextPosition end,
        DependencyObject properties);
    TextHighlight(
        TextPosition start, TextPosition end,
        DependencyObject properties,
        bool movable);
    // Highlighting properties bag
}
class TextMultiHighlight : TextMultiRange
{
    // Constructors
    TextMultiHighlight( );
    TextMultiHighlight(DependencyObject properties);
    // Applying a highlight
    virtual object GetValue(
        TextPosition position, DependencyProperty property);
}
```

Note that this organization of TextHighlights enables the following scenario. Spellchecked creates it own collection of highlighted ranges in its instance of TextHighlight (spellerHighlights). At the same time TextSelection creates its own instance of TextHighlight (selectionHighlight). Each of them associates different highlighting properties with their range collections. Each of them then adds its TextHighlight to TextView. Highlight (which is another TextHighlight with its own Highlight property equal to null because it does not want to override more specific highlight settings). Finally, TextView starts rendering its text content and applies this combination of highlights. Highlight properties may conflict—because of range overlapping or because of overriding on higher levels of TextMultiRanges.

Referring back now to FIG. 4, the data model 156 and view model 158 of the text object model 400 include manipulation tools 430-438 that can be accessed and brought to bear on objects 404-416 in the text container 420 via user interactions 302 mentioned above. These manipulation tools include movable text position tool 430, non-movable text position tool 432, a text navigator tool 434, a text range tool 436, and a MultiText range tool 438. Each of these tools may be applied to each of the concept objects 404, 406, 408, 410, 412, 414 and 416 separately or in various combinations as may be required by the user instructions. Each of the tools 432-438 is drawn from the text store 306 and may be applied via the text object model 400 to any one of the concept objects 404-416 separately or in combination as demanded by user interactions 302.

The embodiment described above is provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

1. A method of handling editing operations of objects on a video display in an application running on a computer system comprising:
providing an application program interface having one or more abstraction layers having a text edit functionality;
detecting an edit operation for an object displayed on the video display by the computer system; and
sending an edit operation request to one of the abstraction layers via the application program interface to initiate editing of the object via the abstraction layer.

2. The method of handling editing operations in claim 1 wherein the application program interface has one or more abstraction layers having a layout editing functionality.

3. The method of handling editing operations in claim 1 wherein the application program interface has a text container abstraction layer for storing a linear piece of text and a text position abstraction layer for identifying a location within the piece of text.

4. The method of handling editing operations in claim 3 further comprising a text navigator abstraction layer for moving between one or more locations within the text container.

5. A system for editing objects displayed by a computer comprising:
a processor; and
a memory coupled with and readable by the processor and containing instructions that, when executed by the processor, cause the processor to detect an edit operation for an object displayed on the video display by the computer system, send an edit operation request from an application program via an application program interface to an abstraction layer within the interface to initiate editing of the object by the abstraction layer causing the abstraction layer to receive the edit operation request, determine a container type for a container in which the object is displayed, read a set of properties related to the object to be edited, read a set of properties related to the container in which the object is displayed to determine a type for the container, and edit the object based on the container type and the received edit operation request.

6. The system according to claim 5 wherein the type of container is a text container having a framework class.

7. The system according to claim 6 wherein the framework class includes a dependency object class used as an abstract representative for text structuring elements.

8. The system according to claim 7 wherein the framework class includes a dependency property object class containing formatting information on the dependency object class.

9. The system according to claim 5 further comprising one or more base types.

10. The system according to claim 9 wherein one of the base types is a logical direction type for indicating direction in linear text space.

11. The system according to claim 6 further comprising an abstract text position class defining a mechanism for identifying location within text in the text container.

12. The system according to claim 6 further comprising an abstract class text navigator providing a content exploration functionality within the object.

13. The system according to claim 6 further comprising a view model for the text container to provide one or more presentational characteristics of the text container.

14. A machine-readable medium encoding a computer program of instructions for editing objects displayed by a computer system, said computer process comprising:
providing an application program interface having one or more abstraction layers having a text edit functionality;
detecting an edit operation for an object displayed by the computer system; and
sending an edit operation request to one of the abstraction layers via the application program interface to initiate editing of the object via the abstraction layer.

15. The medium of claim 14 wherein the application program interface has one or more abstraction layers having a layout editing functionality.

16. The medium of claim 15 wherein the application program interface has a text container abstraction layer for storing a linear piece of text and a text position abstraction layer for identifying a location within the piece of text.

17. The medium of claim 16 further comprising the interface having a text navigator abstraction layer for moving between one or more locations within the text container.
